(19) United States
(12) Patent Application Publication
(10) Pub. No.: US 2005/0028926 A1
(43) Pub. Date: Feb. 10, 2005

(54) Sealing method

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/636,826

(22) Filed: Aug. 7, 2003

(51) Int. Cl. B32B 31/20

(52) U.S. Cl. 156/308.2; 156/145

(57) ABSTRACT

A method for sealing the ends of plastic tubes is disclosed. The sealing method provides a means to relieve the air pressure due to the heated air within a plastic tube thereby allowing the plastic tube to be reliably sealed with a heated surface. An air escape opening is provided near the end of the plastic tube. When the end of the plastic tube is heated, the air within the plastic tube will escape through the air escape opening to relieve the pressure within the plastic tube and maintains a constant atmospheric pressure as the heated surface softens and melts the plastic at the end of the plastic tube. As the air escape opening is sealed, the sealing of the open end of the plastic tube is also completed. As the heat source is removed, the air pressure within the sealed plastic tube will not have sufficient force to rupture the sealed end thereby the plastic tube is sealed reliably.

### BACKGROUND

1. Field of Invention

The present invention relates generally to a method for sealing tubular members. More specifically, the present invention is a sealing method for sealing the ends of plastic tubular members.

### BACKGROUND

2. Description of Related Art

Plastic tubes are used in a variety of applications such as a conduit to transport fluids from one point to another and as a container to store fluids. When plastic tubes are used as containers, one or both ends must be sealed. A variety of sealing method may be used to seal one end of the plastic tube.

The most economical and efficient method of sealing the end of the plastic tube is by applying a heated surface to the end of the plastic tube thereby melting the end of the plastic tube and sealing itself. During this process, the end of the plastic tube is being heated to near the melting temperature of the plastic. Naturally, the air inside the plastic tube as well as the section of the plastic tube near the heat source will also be heated. The heated air will expand in volume resulting in an increase in pressure, which will cause some of the air to be expelled through the other open end of the plastic tube. After the heat source is removed the plastic hardens and the end of the plastic tube is thereby sealed. At this point, the plastic tube may be used as a container and a fluid may be injected into the plastic tube with one of its ends sealed.

However, the same heat sealing method will not satisfactorily and reliably seal the remaining open end of the plastic tube. When the same heat-sealing method is applied to the remaining open end of the plastic tube, the remaining air inside the plastic tube will be heated to an elevated temperature resulting in expansion of the volume of air and higher pressure inside the plastic tube. The heated air with the increased pressure cannot exit the plastic tube and pressure builds-up within the sealed plastic tube. As the plastic is being melted and the remaining open end of the plastic tube is being sealed, the air pressure due to the heated air within the plastic tube will exert a force against all interior surfaces of the plastic tube, including the melted plastic. As soon as the heated surface is removed from the end of the plastic tube and before the melted plastic is able to solidify sufficiently to withstand the air pressure within the sealed plastic tube, the pressure of the heated air within the sealed plastic tube will push through the soft plastic and destroy the plastic seal.

Some other methods to seal the remaining open end of the plastic tube are by using a screw-on cap, by affixing a plug to the open end of the plastic tube, and by sealing the open end of the plastic tube with an adhesive. However, these methods require additional parts and are not economical or efficient. Therefore, a reliable and economical method of sealing both ends of a plastic tube is desired.

### SUMMARY OF THE INVENTION

The present invention is a method to seal the ends of a plastic tube. The sealing method provides a means to relieve the air pressure due to the heated air within a plastic tube thereby allowing the plastic tube to be reliably sealed with a heated surface. An air escape opening is provided near the end of the plastic tube. When the end of the plastic tube is heated, the air within the plastic tube will escape through the air escape opening to relieve the pressure within the plastic tube and maintains a constant atmospheric pressure as the heated surface softens and melts the plastic at the end of the plastic tube. As the air escape opening is sealed, the sealing of the open end of the plastic tube is also completed. As the heat source is removed, the air pressure within the sealed plastic tube will not have sufficient force to rupture the sealed end thereby the plastic tube is sealed reliably.

### BRIEF DESCRIPTION OF THE DRAWINGS

FIG. 1 shows the preferred embodiment of the sealing method at the beginning of the operation.

FIG. 2 shows the preferred embodiment of the sealing method during operation.

FIG. 3 shows the preferred embodiment of the sealing method at the end of the operation.

FIG. 4 shows another embodiment of the sealing method at the beginning of the operation.

FIG. 5 shows the embodiment of the sealing method shown in FIG. 4 during operation.

FIG. 6 shows the embodiment of the sealing method shown in FIG. 4 at the end of the operation.

FIG. 7 shows another embodiment of the sealing method at the beginning of the operation.

FIG. 8 shows the embodiment of the sealing method shown in FIG. 7 during operation.

FIG. 9 shows the embodiment of the sealing method shown in FIG. 7 at the end of the operation.

### DETAILED DESCRIPTION OF THE PREFERRED EMBODIMENT

The sealing method provides an air escape means near the end of a plastic tube to relieve the air pressure due to the heated air within the plastic tube thereby allowing the plastic tube to be reliably sealed with a heated surface. When the end of the plastic tube is heated, the air within the plastic tube will escape through the air escape means to relieve the pressure within the plastic tube and maintains a constant atmospheric pressure as the heated surface softens and melts the plastic at the end of the plastic tube. As the air escape mean is sealed by the heated surface, the sealing of the open end of the plastic tube is also completed. As the heat source is removed, the air pressure within the sealed plastic tube will not have sufficient force to rupture the sealed end thereby the plastic tube is sealed reliably.

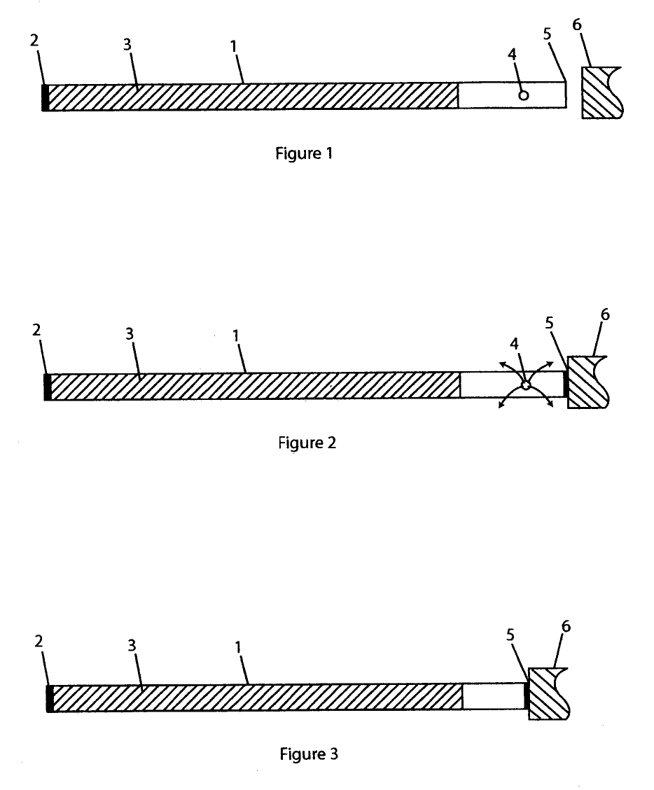

FIG. 1 shows the preferred embodiment of the present invention in detail. In the preferred embodiment, one end 2 of a plastic tube 1 is first sealed. The seal may be by heating the end 2 with a heated surface to a temperature sufficient to melt the plastic to form a seal at the end 2 of the plastic tube 1. A fluid 3 may be injected into the plastic tube 1 after one end 2 is sealed. A hole 4 is provided through its wall near the other end 5 of the plastic tube 1 for the air to escape during the heating of the remaining open end 5. As shown in FIG. 2, a heated surface 6 is then applied to the remaining open end 5 of the plastic tube 1, melting the plastic at the end 5 of the remaining open end 5 of the plastic tube 1. The air that is heated by the heated surface 6 will escape through the hole 4 near the end 5 being sealed thereby maintaining an atmospheric pressure inside the plastic tube 1. As the sealing of the remaining open end 5 is near completion, the hole 4 will be sealed and the plastic tube 1 will be sealed on both ends 2, 5 as shown in FIG. 3. Any remaining air pressure will not have sufficient force to rupture the seal and a reliable seal is formed. The plastic tube 1 will be completely seal on both ends 2, 5.

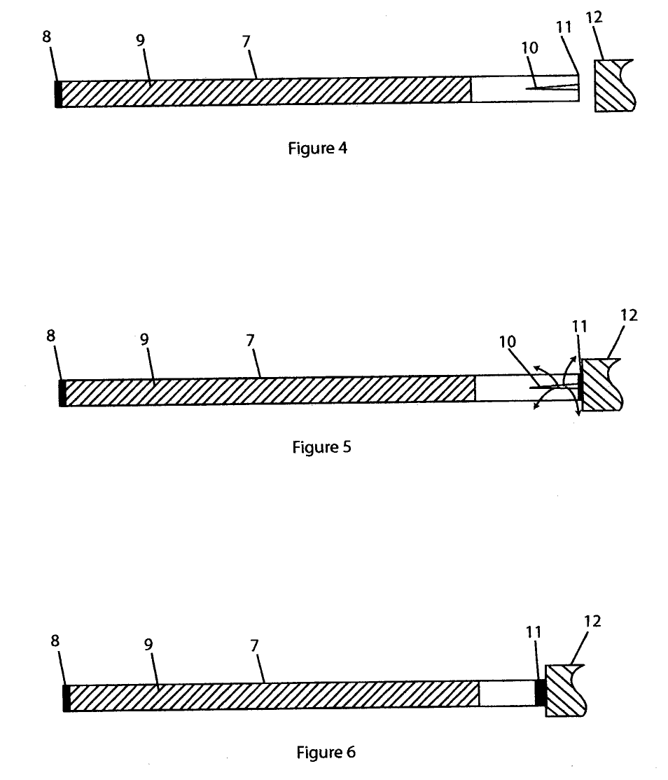

FIG. 4 shows another embodiment of the present invention. In this embodiment, one end 8 of a plastic tube 7 is first sealed. The seal may be by heating the end 8 with a heated surface to a temperature sufficient to melt the plastic to form a seal at the end of the plastic tube 7. A fluid 9 may be injected into the plastic tube 7 after one end 8 is sealed. A slit 10 through the wall of the plastic tube 7 is provided near the other end 11 of the plastic tube 7 extending for a predetermined distance away from the end 11 of the plastic tube 7 for the air to escape during the heating of the remaining open end 11. As shown in FIG. 5, a heated surface 12 is then applied to the remaining open end 11 of the plastic tube 7, melting the plastic at the end 11 of the remaining open end 11 of the plastic tube 7. The air that is heated by the heated surface 12 will escape through the slit 10 near the end 11 being sealed thereby maintaining an atmospheric pressure inside the plastic tube 7. As the sealing of the remaining open end 11 is near completion, the slit 10 will be sealed and the plastic tube 7 will be sealed on both ends 8, 11 as shown in FIG. 6. Any remaining air pressure will not have sufficient force to rupture the seal and a reliable seal is formed. The plastic tube 7 will be completely seal on both ends 8, 11.

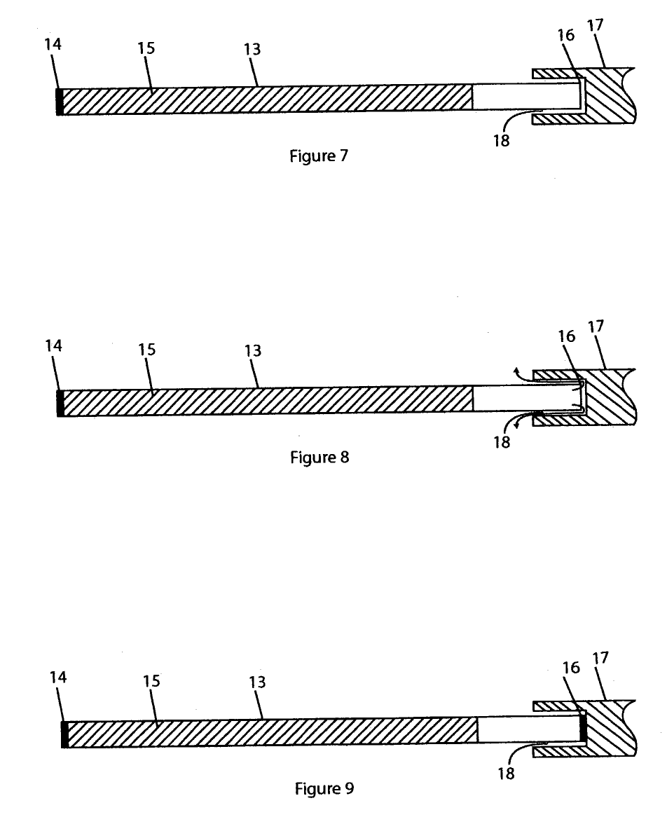

FIG. 7 shows another embodiment of the present invention. In this embodiment, one end 14 of a plastic tube 13 is first sealed. The seal may be by heating the end 14 with a heated surface to a temperature sufficient to melt the plastic to form a seal at the end 14 of the plastic tube 13. A fluid 15 may be injected into the plastic tube 13 after one end 14 is sealed. As shown in FIG. 8, heat is then applied to the open end 16 of the plastic tube 13 by a heated surface 17 with a recess 18 in the approximate form of the end 16 of the plastic tube 13, raising the temperature of the air in the plastic tube 13 to near the melting temperature of the plastic tube 13 while allowing the heated air to escape out of the plastic tube 13 to maintain a constant atmospheric pressure. After the air in the plastic tube 13 is raised to near the melting temperature of the plastic tube 13, the heated surface 17 then applies pressure to the open end 16 of the plastic tube 13, melting the open end 16 of the plastic tube 13 and sealing the open end 16 of the plastic tube 13 as shown in FIG. 9. Any remaining air pressure will not have sufficient force to rupture the seal and a reliable seal is formed. The plastic tube 13 will be completely seal on both ends 14, 16.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

1. A sealing method comprising the steps of:
sealing a first end of a plastic tube; and
sealing a second end of said plastic tube with an air escape means provided near said second end;
whereby the plastic tube is sealed on both ends.

2. A sealing method as in claim 1, wherein the sealing of said second end of said plastic tube is by a heated surface.

3. A sealing method as in claim 2, wherein said air escape means is a hole through the wall of the plastic tube near said second end.

4. A sealing method as in claim 2, wherein said air escape means is a slit extending from said second end of said plastic tube.

5. A sealing method as in claim 1, wherein a fluid is injected into the plastic tube after the first end of the plastic tube is sealed.

6. A sealing method as in claim 5, wherein said air escape means is a hole through the wall of the plastic tube near said second end.

7. A sealing method as in claim 5, wherein said air escape means is a slit extending from said second end of said plastic tube.

8. A sealing method comprising the steps of:
sealing a first end of a plastic tube;
heating a second end of said plastic tube while allowing the air in said plastic tube to escape through said second end; and
sealing said second end of said plastic tube;
whereby the plastic tube is sealed on both ends.

9. A sealing method as in claim 8, wherein a fluid is injected into the plastic tube after the first end of the plastic tube is sealed.

10. A sealing method as in claim 8, wherein said second end is heated to near the temperature that sealing of the second end will occur.

11. A sealing method as in claim 8, wherein the heating of said second end of said plastic tube is by a heating element with an end in the form of a recess approximately the size and profile of the second end of said plastic tube.

12. A sealing method as in claim 9, wherein said second end is heated to near the temperature that sealing of the second end will occur.

13. A sealing method as in claim 9, wherein the heating of said second end of said plastic tube is by a heating element with an end in the form of a recess approximately the size and profile of the second end of said plastic tube.

14. A sealing method as in claim 12, wherein the heating of said second end of said plastic tube is by a heating element with an end in the form of a recess approximately the size and profile of the second end of said plastic tube.
